(19) United States
(12) Patent Application Publication
(10) Pub. No.: US 2024/0418282 A1
(43) Pub. Date: Dec. 19, 2024

(54) VALVE WITH REPLACEABLE HARD INSERTS

(71) Applicant: Wanner Engineering, Inc., Minneapolis, MN (US)

(72) Inventors: Dustin Featherstone, Hastings, MN (US); Richard Hembree, Port Coquitlam (CA)

(21) Appl. No.: 18/744,141

(22) Filed: Jun. 14, 2024

Related U.S. Application Data
(60) Provisional application No. 63/508,823, filed on Jun. 16, 2023.

(51) Int. Cl. F16K 25/00; F16K 1/36; F16K 1/42

(52) U.S. Cl. CPC F16K 25/005; F16K 1/36; F16K 1/42

(57) ABSTRACT

A valve includes a valve disc movable along an axial direction and has an arcing outer engagement surface with an axis of curvature transverse to the axial direction. A valve seat defines a central opening aligned with the axial direction. The valve seat has a toroidal radially inner engagement surface around the central opening configured to engage the engagement surface of the valve disc in a closed position. The engagement surface of the valve disc and the engagement surface of the valve seat are configured to form a line of contact between the outer engagement surface and the inner engagement surface. The engagement surfaces of the valve disc and of the valve seat may be a carbide or ceramic material having a hardness of 1000 HV or more.

### BACKGROUND OF THE INVENTION

### Field of the Invention

The present invention relates to a valve and valve seat having a disc shaped element engaging a toroidal shaped complementary seat.

Pumps used in pumping abrasive slurries suffer from rapid valve wear that leads to valve leakage and reduced performance. A frequent problem is the particles in the slurry get trapped between the valve disc and seat mating surfaces, thereby preventing the valves from fully closing.

To reduce the wear and loss of performance, it is common for slurry pumps to use an elastomeric sealing element to seal even if the hard surfaces of the valve are held apart by the particles in the slurry.

To achieve good sealing of such valves used in environments with an abrasive fluid, it has been found that the contact zone should remain small. A larger contact surface area increases the possibility of particles becoming wedged between the engagement surfaces, thereby decreasing the effectiveness of the seal. If one or both sealing surfaces are made of a material that is only slightly harder than the abrasive slurry, the engagement surface will wear away and result in a larger and larger contact area. Large particle will more easily land on this large area and the particles will hold the valve slightly open. This failure to fully close will allow fluid to pass through the valve at a high velocity resulting in abrading a leak path in the metal. This is often referred to as washing out a valve. It has been found that if both the seat and the disc are made of a very hard material longer life can be achieved. Such materials include carbide, ceramic, or cermet, a composite of ceramic and metal materials.

A common valve design has a disc with a conical contact surface, mating with a conical seat surface. In slurries this creates a large surface area where particles can land and resist full closure of the valve. It is common in this type of valve to use an elastomeric sealing element to seal over the particles. However, it has been found that particles still get trapped in the conical area downstream of the seal creating a gap that the seal extrudes into. This process eventually nibbles away at the seal element until it is unable to properly seal. Another issue with this arrangement is the sealing element contacts over a large area and causes a pressure imbalance with a pressure spike that may open the discharge valve.

Sintered cemented carbide, or a tungsten carbide alloy, generally referred to as carbide, is a hard material that resists wear and is used in valves for slurries containing particles that may wear away pump surfaces. However, carbide is also a heavy and expensive material and the use of carbide and need to replace a carbide valve increases weight and cost. If the weight becomes too great, the valve may not open and close quickly enough. Therefore, a carbide insert would provide the advantages of a hard erosion resistant surface without the costs and weight of a valve made entirely of carbide.

A hardened valve seat disclosed in U.S. Pat. No. 10,718,441 to Myers is for a Valve Seat with a Hardened Sleeve Interior and a Metal Exterior. The Myers patent shows a valve with an elastomer seal that engages a conical seat. However, both the disc and the seat have conical contact zones that can be held apart by jammed particles, therefore there is a need for a flexible seal. The Myers valve seat has hard materials on the contact surfaces, but surfaces may be unable to seal because of the conical shape.

U.S. Pat. No. 10,711,778 to Buckley is for a Frac Pump Valve Assembly. Buckley also shows hard inserts on a valve disc with a conical section mating with a conical seat. With this cone on cone structure an elastomer seal is needed.

It can therefore be appreciated that a new and improved valve seat with superior sealing and wear characteristics is needed. It is therefore an object of the present invention to eliminate the elastomeric seal while still maintaining good sealing. It is also appreciated that there is a need for replaceable carbide sealing inserts for both the disk and the complementary seat that have a reduced contact area for sealing while other elements use lighter materials. The present invention address these problems, as well as others, associated with valve seats used with a slurry containing harsh particles.

### SUMMARY OF THE INVENTION

The present invention is directed to a valve and valve seat having a disc shaped element engaging a toroidal shaped complementary seat and a pump having such a valve and valve seat.

A pump, such as a diaphragm pump, may be driven by connection to a rotating crankshaft mounted in a crankcase. In some embodiments, a manifold houses one or more check valves. The pump may include multiple diaphragms and associated components connected to the crankshaft.

A diaphragm pump includes a diaphragm assembly including a diaphragm. The diaphragm is driven by hydraulic fluid that is contained in a hydraulic chamber, in a reservoir, and/or a plunger chamber. The pumping chamber is on a hydraulic side of the diaphragm. The hydraulic fluid is forced against the diaphragm to deflect the hydraulic side of the diaphragm and impart a pumping action by the diaphragm on the fluid to be pumped. It can be appreciated that in some embodiments, the crankshaft may attach to multiple different diaphragms within the same pump assembly and may include offset portions along the shaft so that individual diaphragms are synchronized to pump at different stages of the pumping stroke. Fluid being pumped is suctioned into the manifold through a manifold inlet passage into the pumping chamber and discharged through a manifold discharge passage by the diaphragm.

The manifold houses inlet check valves and discharge check valves. In embodiments with multiple diaphragms, the pump includes an inlet check valve and a discharge check valve for each of the diaphragms. The check valves provide for controlled suction and discharge of the pumped fluid into the inlet passage and out through the outlet passage.

Each of the check valves is configured with a valve assembly. The valve assembly includes a valve disc assembly that mates with a valve seat assembly. The valve disc assembly has a valve body which supports a hard disc insert. In one embodiment, the insert disc is made of a hard material, such as a sintered cemented carbide, a ceramic, cermet, or other material having a very high hardness and fracture resistance. The disc insert has a spherical surface that mates with a seat insert of the valve seat assembly. The valve disc assembly includes a helical spring extending around a cylindrical stem portion of the valve body or other biasing member. The spring engages a cap and pushes against a valve body disc. The disc insert mounts to the valve body disc and is held in place by a retainer. The disc insert includes external threaded connection with internal threads of the retainer engaging an end external threaded portion on the valve body. The retainer is coupled and uncoupled by relative rotation between the valve body and retainer. A seal element seals the insert to the valve body. Mounting elements, such as screws, insert into the mounting holes to engage recesses and further tighten the retainer against the disc insert.

The valve seat assembly includes a base that is configured to fit into a passageway in a pump fluid head. The valve seat assembly supports the hard seat insert that has a toroidal (convex) surface that mates with the valve disc insert when the valve is closed. The seat insert is sealed to the base with a seal. The seat insert is held in place by a retainer which has a threaded connection with the seat base with internal threads on the retainer engaging external threads on the seat base. In one embodiment, the retainer includes externally facing notches that are configured to receive a complementary tool to engage the retainer can be used to tighten the retainer against the seat insert.

To solve the problems associated with an elastomer seal in a harsh pumping environment, the valve of the present invention eliminates the need for an elastomer by reducing the contact zone to a small enough area, such as a radial line of contact. The line of contact is created by a line of contact on the spherical surface of the disc insert engaging a complementary line of contact on the toroidal surface of the seat insert. The line of contact is sufficiently small to minimize or eliminate trapping of particles between the spherical engagement surface and the toroidal engagement surface so there is no significant leakage. It has been found that the contact surface between a spherical disc and a toroidal seat and the shapes and orientations of the contact surfaces tend to prevent particles from becoming trapped and help to direct particles away from the contact line and provide significantly better sealing than sphere on cone or cone on cone sealing pairs. Moreover, the need for a seal element between the valve disc assembly and the valve seat assembly can be eliminated. The improved engagement with greatly reduced particle entrapment and avoidance of a seal element increases performance and life of the valve. With the pump and valve according to the present invention, higher efficiency and longer life are achieved with only hardened carbide surfaces engaging one another and exposed to the hazard of particle entrapment. By using carbide only for hardened inserts, costs are reduced, and overall weight is reduced compared to a valve with additional components made of sintered carbide. Furthermore, should wear occur, the inserts may be replaced to extend the life of the valve.

It can be appreciated that the engagement surfaces and having opposite arcing surfaces achieve improved engagement, performance and wear. Such complementary convex surfaces create a line of engagement and channel particles away from the line of contact. Moreover, the area of contact in which particles may be trapped is greatly reduced.

It has been found that a relative diameter of the engagement surfaces and the angle tangent the contact line can affect the performance of the valve. It can be appreciated that the valve disc assembly defines a center longitudinal axis extending through the valve body. The curvature of the contact surface at the point of contact is centered on an axis of curvature. A radius is therefore defined between center of curvature and the point of contact. It is also appreciated that a radius of curvature is defined for the contact surface at the point of contact. An angle is formed between the radius of curvature and the longitudinal axis of the valve assembly. Furthermore, a contact diameter is defined at the radial line of contact.

It has been found that improved performance is obtained if the radius of curvature at the line of contact is larger than the radius of the contact surface. Furthermore, it has been found that superior performance is achieved if the ratio between the radius of curvature of the disk at the line of contact is approximately seven times the radius of the contact surface of the seat.

Moreover, the relative positions and dimensions of the valve components can be varied to control the angle between the radius defined by the curvature at the line of contact and the longitudinal axis has been found to affect performance. It has been found that improved performance is obtained if the angle is between 20° and 45°. Furthermore, it has been found that improved performance is obtained if the angle is approximately 30°.

According to one example, the present invention is a valve apparatus including a valve disc movable along an axial direction and having an arcing outer engagement surface having an axis of curvature transverse to the axial direction, and a valve seat having a central opening aligned with the axial direction, the valve seat having a toroidal radially inner engagement surface around the central opening configured to engage the engagement surface of the valve disc in a closed position. The engagement surface of the valve disc and the engagement surface of the valve seat are configured to form a line of contact between the outer engagement surface and the inner engagement surface. In addition, in one example, the valve disc engagement surface and the valve seat engagement surface are replaceable carbide inserts.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings wherein like reference numerals and letters indicate corresponding structure throughout the several views:

FIG. 1 is a perspective view of a diaphragm pump according to the principles of the present invention;

FIG. 2 is a rear elevational view of the diaphragm pump shown in FIG. 1;

FIG. 3 is a sectional view of the pump taken along line 3-3 of FIG. 2;

FIG. 4 is a front elevational view of the pumping chamber for the pump shown in FIG. 1;

FIG. 5 is a sectional view of a manifold taken along line 5-5 of FIG. 4;

FIG. 6 is a side elevational view of a valve assembly for the manifold shown in FIG. 5;

FIG. 7 is a sectional view of the valve assembly taken along line 7-7 of FIG. 6;

FIG. 8 is an exploded view of the valve assembly shown in FIG. 6;

FIG. 9 is a side view of the valve assembly shown in FIG. 5 with a valve disc assembly seated in the valve seat assembly;

FIG. 10 is a sectional view of the valve assembly taken along line 10-10 of FIG. 9;

FIG. 11 is a bottom perspective view of a first embodiment of a valve disc assembly for the valve assembly shown in FIG. 6;

FIG. 12 is a bottom exploded view of the valve disc assembly shown in FIG. 11;

FIG. 13 is a bottom perspective view of a second embodiment of a valve disc assembly for the valve assembly shown in FIG. 6;

FIG. 14 is a bottom exploded view of the valve disc assembly shown in FIG. 13;

FIG. 15 is a perspective view of a valve disc seat assembly for the valve assembly shown in FIG. 6;

FIG. 16 is an exploded view of the valve seat assembly shown in FIG. 15;

FIG. 17 is a sectional detail view of the engagement surfaces between the valve disc and the valve seat; and

FIG. 18 is a side sectional view of the valve assembly shown in FIG. 7 with the geometric parameters of the engagement surfaces and their relationship at the point of contact.

### DETAILED DESCRIPTION OF THE PREFERRED EMBODIMENT

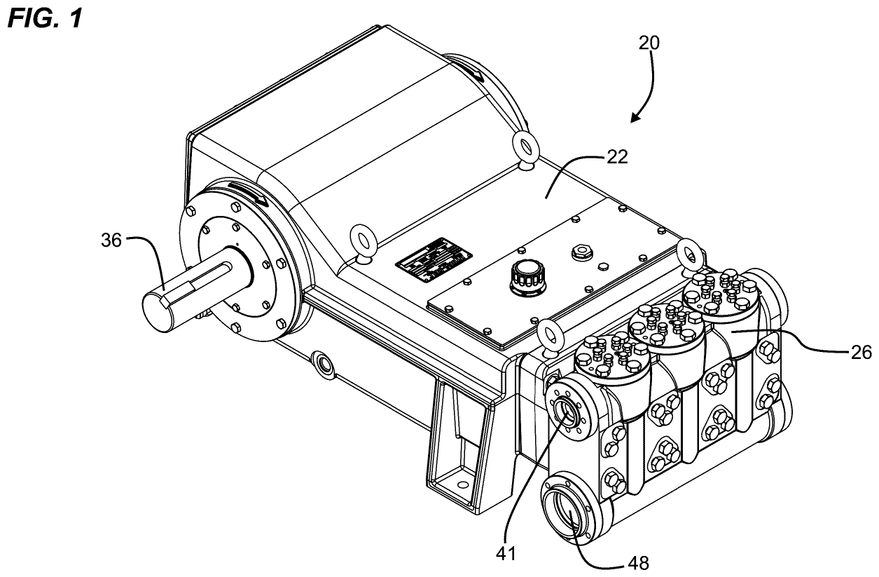

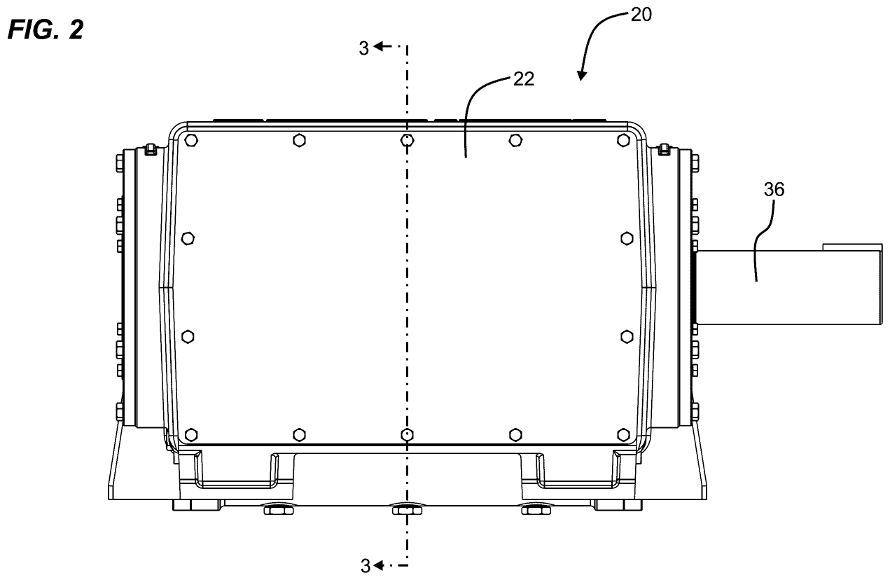

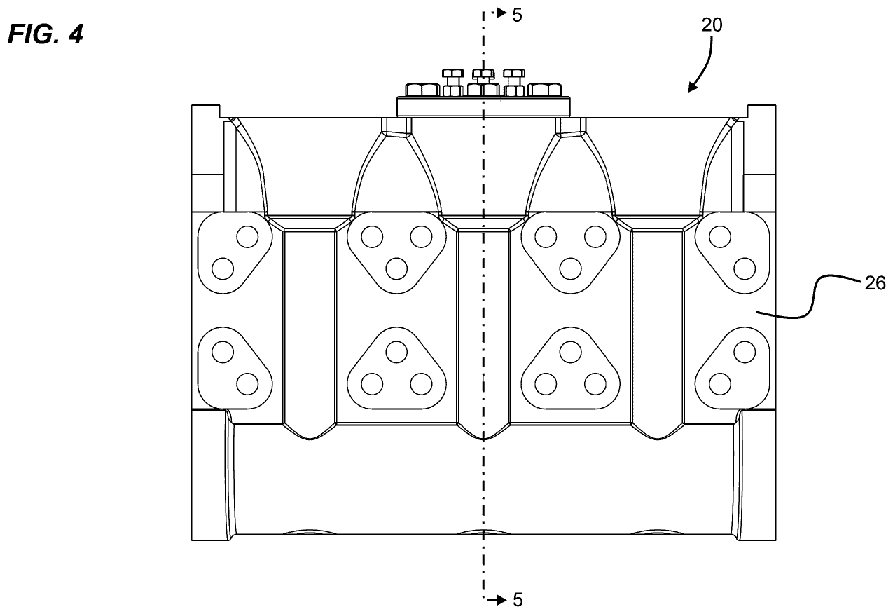

Referring now to the drawings and in particular to FIGS. 1-4, there is shown a fluid pump (20), such as a hydraulically driven diaphragm pump although a positive displacement pump is also foreseen. The diaphragm pump (20) is driven by connection to a rotating crankshaft (36) mounted in a crankcase (22). A manifold (26) houses one or more check valves (60, 70). The pump (20) may include multiple diaphragms assemblies and associated components connected to the crankshaft (36).

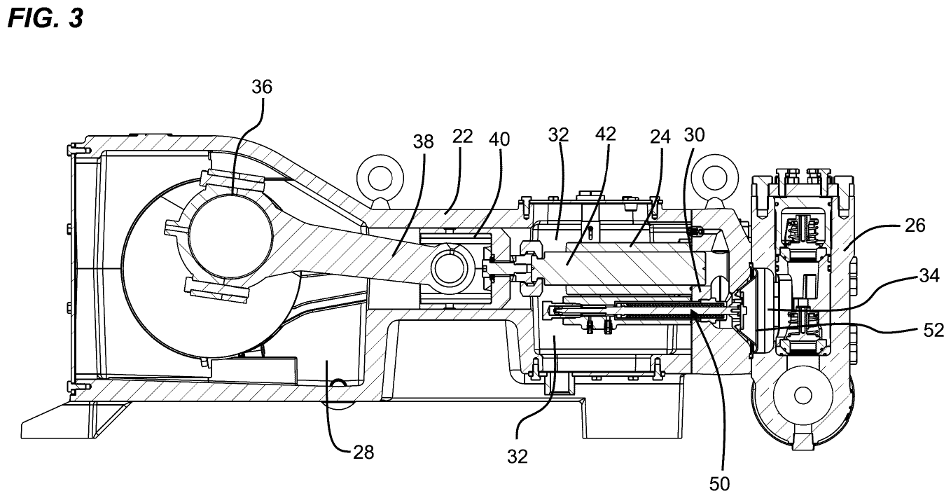

Referring now to FIG. 3, the pump (20) includes a diaphragm assembly generally designated (50) including a diaphragm (52). The diaphragm (52) is driven by hydraulic fluid that is contained in a hydraulic chamber (30), a reservoir (28), and a plunger chamber (32). The pumping chamber (34) is on a hydraulic side of the diaphragm (52). The hydraulic fluid has access to engage the diaphragm assembly (50) through the hydraulic chamber (30). The hydraulic fluid is forced against the diaphragm (52) to deflect the hydraulic side of the diaphragm (52) and impart a pumping action on the fluid to be pumped. A piston housing (24) defines the plunger chamber (32). The crankshaft (36) includes a connecting rod (38) attached to a slider (40) in the crankcase (22). The slider (40) is connected to a piston-type plunger (42) that reciprocates and drives the hydraulic fluid from the hydraulic chamber (30) to engage the diaphragm (52). It can be appreciated that in some embodiments, the crankshaft (36) may attach to multiple different diaphragm assemblies (50) within the same pump and may include offset portions along the shaft so that individual diaphragms are synchronized to pump at various stages of the pumping stroke. Fluid being pumped is suctioned into the manifold (26) through a manifold inlet passage (46) into the pumping chamber (34) and discharged through a manifold discharge passage by the diaphragm (52). The diaphragm (52) is typically relatively large in diameter and configured to deflect a relatively small amount. The short stroke of the diaphragm (52) is driven by the larger stroke of the plunger (42). The longer stroke of the plunger (42) allows the plunger (42) to use a smaller diameter and impart smaller loads on the crankshaft (36) and crankcase (22) of the pump (20) and therefore imparts less stress.

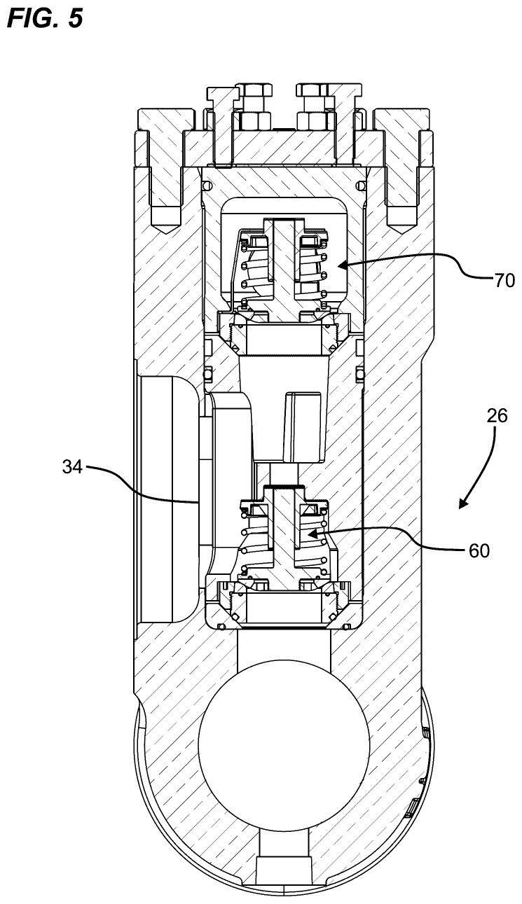

As shown in FIG. 5, the manifold (26) houses inlet check valves (60) and discharge check valves (70). In embodiments with multiple diaphragms (52), the pump (20) includes an inlet check valve (60) and a discharge check valve (70) for each of the diaphragms (52). The check valves (60, 70) provide for controlled suction and discharge of the pumped fluid into the inlet passage (46) and out through the outlet passage (48).

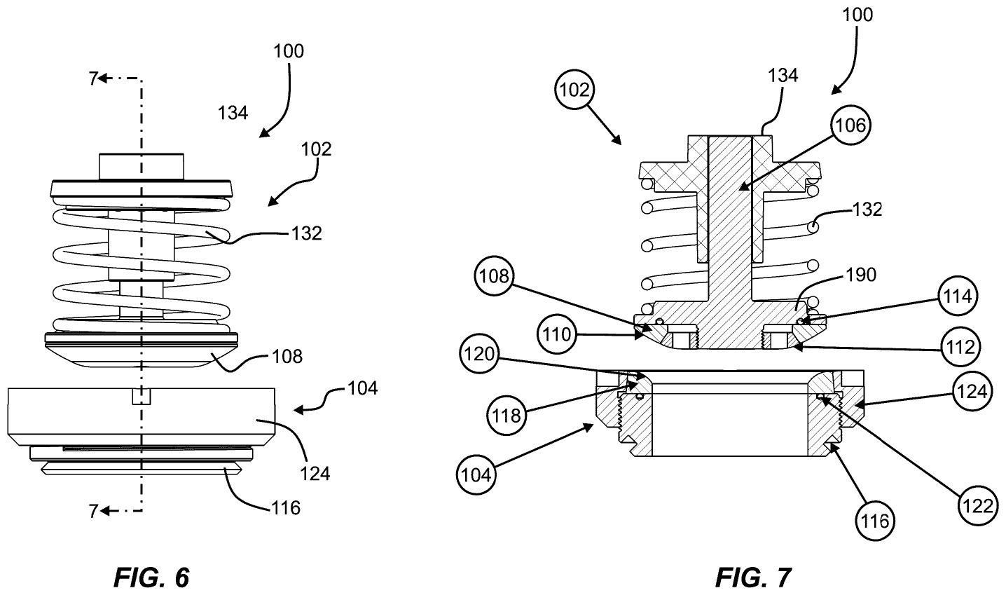

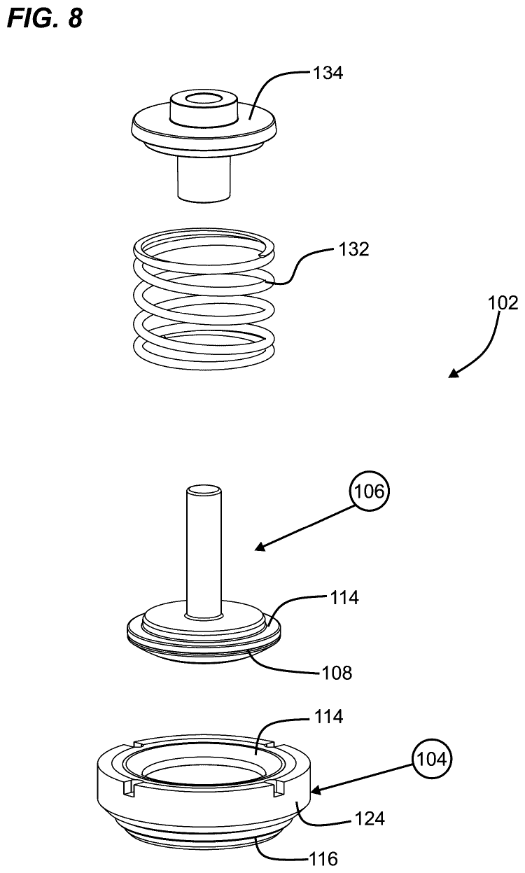

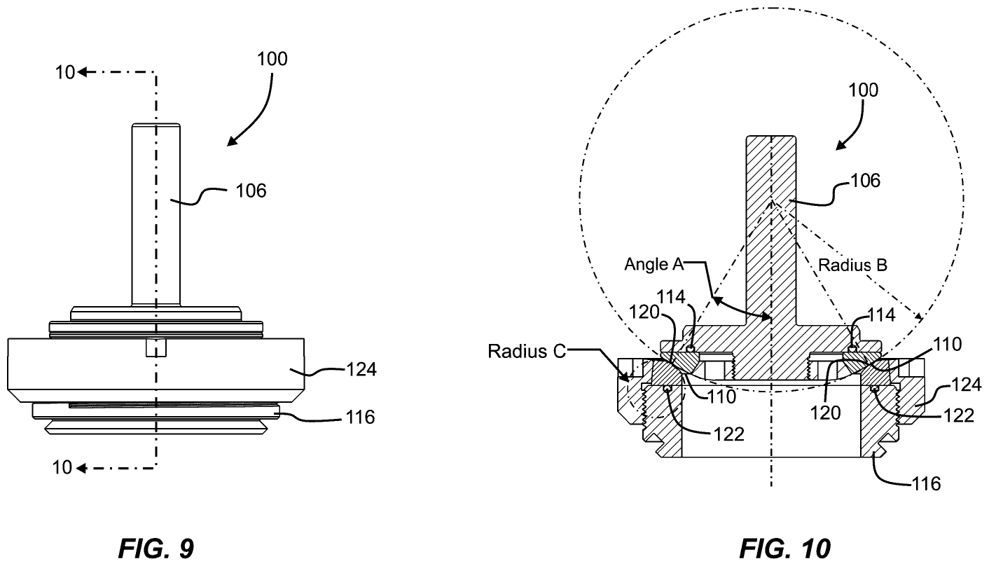

Referring to FIGS. 6-10, each of the check valves (60, 70) is configured with a valve assembly (100). The valve assembly (100) includes a valve disc assembly (102) that mates with a valve seat assembly (104). The valve disc assembly (102) has a valve body (106) that supports a hard disc insert (108). In one embodiment, the disc insert (108) is made of a sintered cemented carbide material, a ceramic material, composites such as cermet, or other materials having a very high hardness and fracture resistance. It has been found that materials having a Vickers number (HV) greater than 1000 HV providing satisfactory performance. Moreover, materials having a hardness of 1600 HV or more perform very well, even if exposed to extremely abrasive slurries. The disc insert (108) has a spherical surface (110) that mates with a seat insert (118) of the valve seat assembly (104).

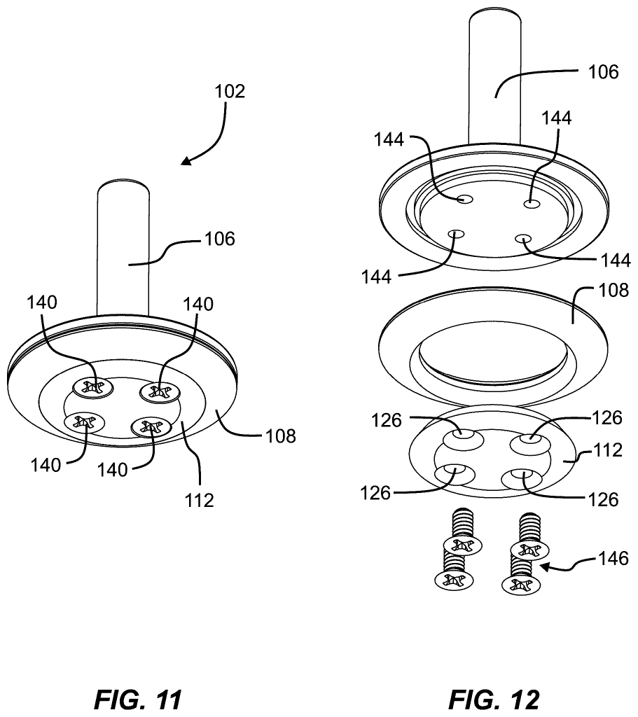

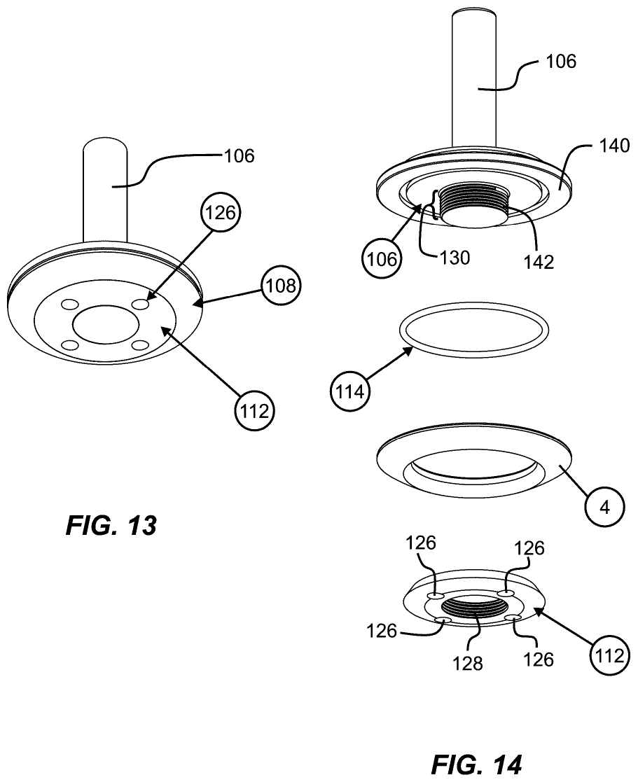

The valve disc assembly (102) includes a helical spring or other biasing member (132) extending around a cylindrical stem portion of the valve body (106). The spring (132) engages a cap (134) and pushes against a valve body disc (140). The disc insert (108) mounts to the valve body disc (140) and is held in place by a retainer (112). The disc insert (108) includes an external threaded connection (142) with internal threads (128) of the retainer (112) engaging an end external threaded portion (130) on the valve body (106), such as shown in FIG. 14. The retainer (112) is coupled and uncoupled by relative rotation between the valve body (106) and the retainer (112). A seal element (114) seals the insert (108) to the valve body (106). As shown in FIGS. 11-14, mounting elements, such as screws (146), insert into the mounting holes (126) to engage recesses (144) and further tighten the retainer (112) against the disc insert (108).

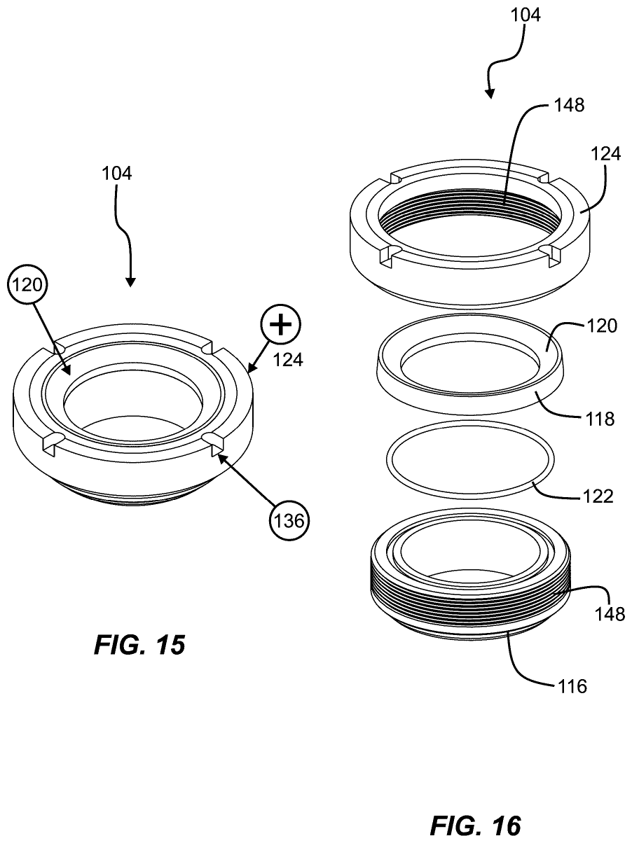

Referring now to FIGS. 15 and 16, the valve seat assembly (104) includes a base (116) that is configured to fit into a passageway in a pump fluid head. The valve seat assembly (104) supports the hard seat insert (118) that has a toroidal surface (120) that mates with the valve disc insert (108) when the valve (100) is closed. The seat insert (118) is sealed to the base (116) with a seal (122). The seat insert (118) is held in place by a retainer (124) which has a threaded connection (148) with the seat base (116) with internal threads on the retainer (124) engaging external threads on the seat base (116). As shown in FIGS. 15 and 16, in one embodiment, the retainer (124) includes externally facing notches (136) that are configured to receive a complementary tool to engage the retainer (112) and can be used to tighten the retainer against the seat insert (118).

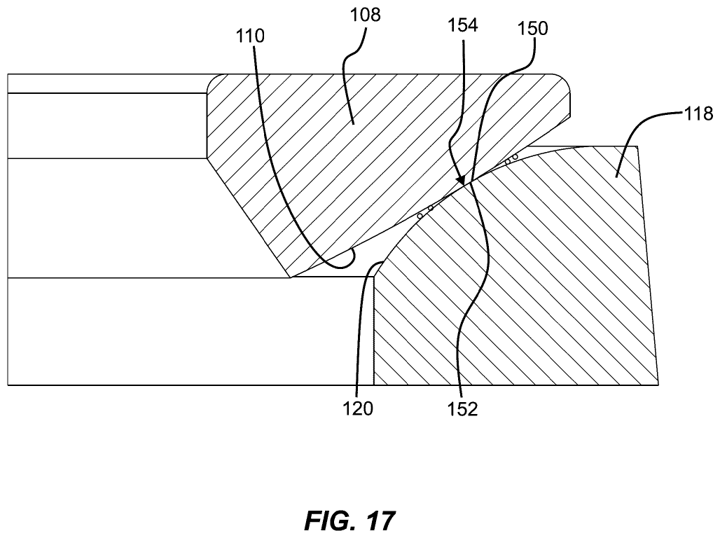

To solve the problems associated with an elastomer seal in a harsh pumping environment, the valve (100) of the present invention eliminates the need for an elastomer by reducing the contact zone to a minimal contact area, such as a radial line of contact (154) shown in FIG. 17. The line of contact (154) is created by a line of contact (150) on the spherical surface (110) of the disc insert (108) engaging a complementary line of contact (152) on the toroidal surface (120) of the seat insert (118). The line of contact (154) is sufficiently small to minimize or eliminate trapping of particles between the spherical engagement surface (110) and the toroidal engagement surface (12) so there is no significant leakage. It has been found that the contact surface between a spherical disc and a toroidal seat tends to prevent particles from becoming trapped and helps to direct particles away from the contact line (154) and provide substantially better sealing than sphere on cone, or cone on cone sealing pairs. Moreover, the need for a seal between the valve disc assembly (102) and the valve seat assembly (104) can be eliminated. The improved engagement with greatly reduced particle entrapment and avoidance of a seal increases performance and life of the valve. With the pump (20) and the valve (100) according to the present invention, this higher efficiency and longer life are achieved with only hardened carbide surfaces (110) and (120) engaging one another and exposed to the hazard of particle entrapment. By using carbide for only hardened inserts (108) and (118), costs are reduced, and overall weight is reduced compared to a valve with additional components made of sintered carbide. Furthermore, should wear occur, the inserts (108) and (118) may be replaced to extend the life of the valve (100).

It can be appreciated that the engagement surfaces (110) and (120) having opposite arcing surfaces achieve improved engagement, performance and wear. Such complementary convex surfaces create an annular line of engagement (154) and channel particles away from the point of contact.

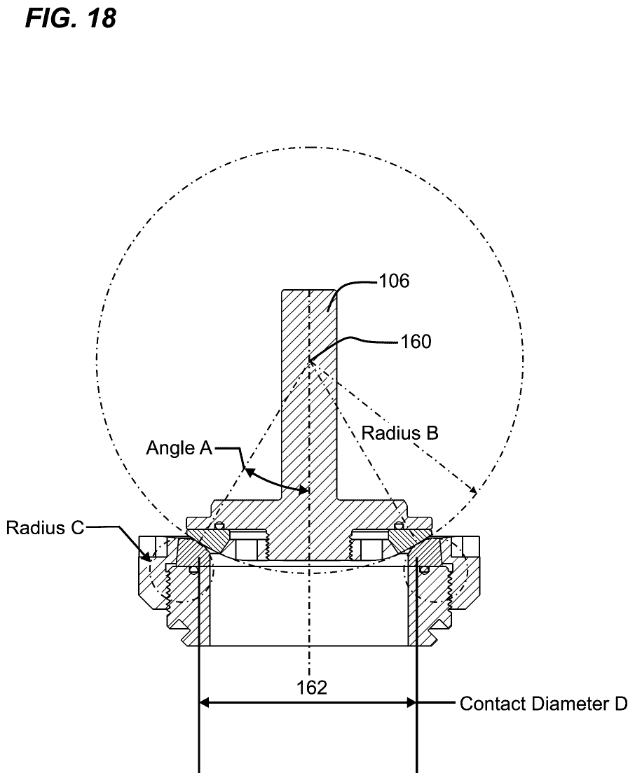

It has been found that a relative diameter of the engagement surfaces (110) and (120) and the angle tangent the contact line (154) can affect performance of the valve (100). Referring to FIG. 18, the relative positions and geometries of the engagement surfaces (110) and (120) for one embodiment are shown. It can be appreciated that the valve disc assembly (102) defines a center longitudinal axis (162) extending through the valve body (106). The curvature of the contact surface (110) at the line of contact (154) is centered on an axis of curvature (160). A radius (B) is therefore defined between a center of curvature (160) and a point at the line of contact (154). It is also appreciated that a radius of curvature (C) is defined for the contact surface (120) at the point of contact (152). An angle (A) is subtended by the radius of curvature (C) and the longitudinal axis (162) of the valve assembly (100). Furthermore, a contact diameter (D) is defined at the line of contact (154).

It has been found that improved performance is obtained if the radius of curvature (B) at the line of contact (154) is larger than the radius (C) of the contact surface (152). Furthermore, it has been found that superior performance is achieved if the ratio between the radius of curvature (B) at the line of contact (154) is approximately seven times the radius (C) of the contact surface (152).

Moreover, the relative positions and dimensions of the valve components can be varied to control the angle (A) between the radius (B) defined by the curvature at a point on the line of contact (154) and the longitudinal axis (162) may also affect performance. It has been found that improved performance is obtained if the angle (A) is between 20° and 45°. Furthermore, it has been found that even greater performance improvement may be obtained if the angle (A) is approximately 30°.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A valve apparatus comprising:
a valve disc movable along an axial direction and having an arcing outer engagement surface having an axis of curvature transverse to the axial direction;
a valve seat having a central opening aligned with the axial direction, the valve seat having a toroidal radially inner engagement surface around the central opening configured to engage the engagement surface of the valve disc in a closed position.

2. The valve apparatus according to claim 1, wherein the engagement surface of the valve disc and the engagement surface of the valve seat are configured to form a line of contact between the outer engagement surface and the inner engagement surface.

3. The valve apparatus according to claim 1, wherein the valve disc has a round outer periphery transverse to the axial direction.

4. The valve apparatus according to claim 1, wherein the engagement surfaces of the valve disc and of the valve seat comprise a carbide, cermet or ceramic material.

5. The valve apparatus according to claim 4, wherein the engagement surfaces of the valve disc and of the valve seat have a hardness of 1000 HV or more.

6. The valve apparatus according to claim 1, wherein the engagement surfaces of the valve disc and of the valve seat have a hardness of 1000 HV or more.

7. The valve apparatus according to claim 1, wherein valve disc comprises a carbide insert forming the valve disc engagement surface.

8. The valve apparatus according to claim 1, wherein valve seat comprises a carbide insert forming the valve seat engagement surface.

9. The valve apparatus according to claim 1, wherein the valve disc engagement surface and the valve seat engagement surface comprise carbide inserts.

10. The valve apparatus according to claim 1, wherein an angle between an axial direction of the valve disc and a radius of the valve seat engagement surface at a point of engagement is at least 20 degrees.

11. The valve apparatus according to claim 1, wherein an angle between an axial direction of the valve disc and a radius of the valve seat engagement surface at a point of engagement is less than 45 degrees.

12. The valve apparatus according to claim 1, wherein an angle between an axial direction of the valve disc and a radius of the valve seat engagement surface at a point of engagement is between 20 degrees and 45 degrees.

13. The valve apparatus according to claim 1, wherein an angle between an axial direction of the valve disc and a radius of the valve seat engagement surface at a point of engagement is about 30 degrees.

14. The valve apparatus according to claim 1, wherein a radius of the valve seat engagement surface at a point of engagement is about seven times a radius of an engagement surface of the valve seat at a point of engagement.

15. The valve apparatus according to claim 1, wherein the engagement surface of the valve disc and the engagement surface of the valve seats curve in opposite directions.

16. A pump comprising a check valve, the check valve comprising the valve apparatus according to claim 1.

17. A valve apparatus comprising:
a valve disc movable along an axial direction and comprising a first replaceable engagement insert having an engagement surface;
a seat having a central opening aligned with the axial direction, the valve seat comprising a second replaceable insert having a complementary engagement surface configured to engage the engagement surface of valve disc in a closed position along a line of engagement.

18. The valve apparatus according to claim 17, wherein the engagement surface of the valve disc and the engagement surface of the valve seat are configured to form a line of contact between the outer engagement surface and the inner engagement surface.

19. The valve apparatus according to claim 18, wherein the engagement surface of the valve disc comprises a spherical engagement surface; and wherein the engagement surface of the valve seat comprises a toroidal radially inner engagement surface.

20. The valve apparatus according to claim 17, wherein an angle between an axial direction of the valve disc and a radius of the valve seat engagement surface at a point of engagement is at least 20 degrees.

21. The valve apparatus according to claim 17, wherein an angle between an axial direction of the valve disc and a radius of the valve seat engagement surface at a point of engagement is less than 45 degrees.

22. The valve apparatus according to claim 17, wherein an angle between an axial direction of the valve disc and a radius of the valve seat engagement surface at a point of engagement is between 20 degrees and 45 degrees.

23. The valve apparatus according to claim 17, wherein an angle between an axial direction of the valve disc and a radius of the valve seat engagement surface at a point of engagement is about 30 degrees.

24. The valve apparatus according to claim 17, wherein a radius of the valve seat engagement surface at a point of engagement is about seven times a radius of an engagement surface of the valve seat at a point of engagement.

25. A valve seat for a fluid end comprising:
a valve seat base;
a replaceable valve insert having a toroidal engagement surface around a central opening and configured to engage a valve disc.

26. The valve seat according to claim 25, wherein the replaceable valve insert comprises a carbide, ceramic or cermet material.

27. The valve seat according to claim 26, wherein the replaceable valve insert has a hardness of 1000 HV or more.

28. The valve seat according to claim 25, wherein the replaceable valve insert has a hardness of 1000 HV or more.

29. The valve seat according to claim 25, further comprising a retainer connecting to the seat base and engaging the insert and holding the valve insert in place.

30. The valve seat according to claim 29, wherein the retainer comprises a threaded connection with the seat base with internal threads on the retainer engaging external threads on the seat base.
